(19) United States
(12) Patent Application Publication
(10) Pub. No.: US 2006/0253434 A1
(43) Pub. Date: Nov. 9, 2006

(54) Auction-based search engine

(76) Inventors: James K. Beriker, Topanga, CA (US); Martha S. Gold, Thousand Oaks, CA (US); Andrew S. Gold, Thousand Oaks, CA (US); Daniel N. Meredith, Claremont, CA (US); Rayford L. Sims, Claremont, CA (US); Alan P. Trzcinko, Simi Valley, CA (US)

Correspondence Address: Robert P. Greenspoon;Niro, Scavone, Haller & Niro, Suite 4600, 181 W. Madison, Chicago, IL, 60602, US

(21) Appl. No.: 11/483,692

(22) Filed: Jul. 10, 2006

Related U.S. Application Data
(63) Continuation of application No. 09/653,840, filed on Sep. 1, 2000.

(51) Int. Cl. G06F 17/30; G06Q 30/00

(52) U.S. Cl. 707/3; 707/6; 705/26

(57) ABSTRACT

Systems and methods are disclosed for electronically generating targeted lists of customers and consumers. To generate the targeted lists, a marketplace search engine initially receives a keyword from a customer as part of a request for content related to the keyword. The search engine obtains and transmits the search results to the customer and then transmits to the customer an invitation to be included in the target list related to the keyword. The marketplace search engine then receives from the customer an acceptance of the invitation to be included in the target list, where the acceptance includes contact information for the customer. The engine addresses the request using the contact information and then transmits a confirmation request. Preferably, the search engine receives a confirmation of the acceptance from the customer; and then adds the contact information for the customer to the targeted list related to the keyword.

This is a continuation of co-pending application Ser. No. 09/653,840 filed Sep. 1, 2000.

### BACKGROUND OF THE INVENTION

1. Field of the Invention

The field of the present invention relates to information technology and advertising, and more particularly, to computer-based methods and systems for providing search results to consumers along with advertisements or offers, and generating consumer data useful for target advertisements or offers.

2. Background

The Internet has become a global marketplace of online merchants scrambling for the attention of millions of consumers. Information on almost any subject is accessible via the Internet. The information, however, is scattered about in literally millions of separate locations or websites. Consequently, search engines and directories—applications that index the content of and record the addresses of millions of individual websites—have become indispensable tools of the Internet.

A search engine is an automated archiving system designed to index the Internet. Generally, a search engine includes a special program called a “spider” or “crawler” which accesses individual websites and copies the files stored in them. The search engine then examines the files, distilling them to essential data, and storing them in a database. The search engine may make the determination as to the type and importance of data stored and, thereby, what information can be searched by end-users of the Internet. In short, an automated process occurs which results in the cataloging of the addresses and content of millions of websites.

Employing a search engine is normally a straightforward process. First, a user who seeks information on a subject enters a search request in a text field of a web browser, where the request may comprise a relevant word, series of words, or a phrase. The user presses “enter”, initiating a transmission of the request to the search engine. The engine then compares the request with its index of the Internet, collecting a set of results that match, and/or at least partially match, the request. The search engine then sorts the results and transmits them to the user's web browser, which then displays the results. The order and nature of these displayed results is preferably determined by each search engine's proprietary relevancy algorithms, the content of the search index, and the user's search request.

Because a search engine is normally automated, it typically add new pages to its index quickly, in some cases less than 24 hours, making search engines the preferred resource for Internet users for locating information on current events. In addition, search engine “spiders” are easily reprogrammed to gather data from sources other than the Worldwide Web, such as newsgroups and File Transmission Protocol (FTP) sites.

Most search engine providers do not actively promote direct access to their databases. Instead, they license their databases to web “portals,” multi-service websites that also serve as primary gateways to other websites, who then repackage and display the results to end-users. Of the top search engine service providers, only Excite® and AltaVista® have their own proprietary search technology. The primary players in search engine service field are Inktomi®, Excite®, AltaVista®, Direct Hit™, Fast™, and Google.com®. Inktomi®, the current leader in this category, provides search services for America Online®, Geocities®, Microsoft®, NBC Snap®, Hotbot® and Yahoo!®.

Similar to search engines in purpose, in that they facilitate users' access to relevant content, a directory is a manual entry system that allows users to locate relevant websites by clicking through tiers of subcategories, narrowing the scope of their searches with each click. Webmasters of content-containing websites locate the appropriate subcategory of their website within the directory, then submit all of the information needed for indexing their site to the website that administers the directory. The submitted information generally includes the website's Unified Resource Locator (URL), its name or title, and a short summary of the website's contents. After submitting the information to the directory's website, a human editor for the directory confirms the data submitted, and inserts the link to the content website into its relevant and logical category within the directory.

Directories are particularly useful for searches on general topics. They also facilitate the location of well-known or established sites, such as media outlets and official corporate pages. However, directories are less effective at locating information on current events, as the editorial review process often takes two weeks or more. Directories are also very labor intensive, as each page must be evaluated and categorized by an editorial staff, and the directory structure itself must be constantly assessed and updated.

While both types of systems (search engines and directories) have elements in common, such as the ability to search an Internet-archiving database for a keyword or phrase, there are several differences between them, one being how each database collects data. Search engines generally collect data automatically while directories accomplish data-collection manually. A second difference relates to how searches are conducted by end-users. Search engines generally require the entry of searchable words or phrases to locate information. Directory searches allow users to locate relevant websites by choosing from categories that the user can then narrow down to more relevant subcategories.

Nevertheless, directory searching presently is most popular method of locating information on the Internet. Many users are frustrated by the lack of relevancy and quality of the returns from search engines, forcing users to spend more time than they would like trying to locate relevant information. Directories offer improved organization and presentation of content, and they help users by guiding them through queries to more relevant content.

Still, even a well-indexed directory may produce no useful or relevant information for a user, because directory searches normally limit the information they provide to a user about a website's content to its title and the descriptive information provided by the website's webmaster.

Further, directories provide no straightforward means for webmasters that have their sites listed in the directories to differentiate themselves from other sites, because directories, such as Yahoo!®, normally display search results alphabetically and at a consistent type size and weight. These lists are also often single-spaced and may contain dozens of entries. Furthermore, Yahoo!® may take up to three months to add the website to its directory.

The searching function, whether performed by search engine or directory, currently is second only to email as the most frequently used tool on the Internet. Consequently, websites providing search services have offered advertisers a new opportunity to capture broad consumer audiences. Typically, search engines generate revenues by selling banner ads or by providing other marketing or co-branding opportunities to advertisers.

In an effort to maximize advertising revenue and electronic commerce opportunities, websites, such as Yahoo!®, are working to increase the number, frequency, and duration of consumer visits to their websites. To more effectively service their existing audiences and provide more valuable advertising vehicles, many such websites are now integrating popular consumer services and content offerings. In traditional media such as television, radio, and print, syndicated content has been widely used by local media in order to augment their core programming and, in so doing, extend audience reach and retention. On the Internet, service providers have emerged that offer websites syndicated services such as search, email, and mapping, as well as content such as stock quotes and news wires. Websites use these offerings to enhance consumer usage, loyalty and retention. Accordingly, these traditionally search-oriented websites have evolved into multi-service portals, which in addition to providing consumers search functionality, deliver a broader array of content and services, in many ways working minimize their original function as “portals” to other websites. Further, by trying to offer “everything to everyone,” these portals have tended to become complex and confusing.

The search services provided by the multi-service portals suffer from several other disadvantages. First, they have had difficulty scaling as the volume and diversity of Internet content has grown. For example, consumers must frequently click through multiple branches of a hierarchical directory to locate relevant websites. While cumbersome for users, this process actually benefits the portals because they can earn additional advertising revenue by exposing consumers to multiple pages.

In addition, the multi-service portals rely upon an unregulated process for assigning results to keywords, a process that often generates irrelevant search listings. Search engines that use automated search technology to catalog search results generally rely on invisible website descriptions or “metatags” that are authored by website operators. Operators may freely tag their websites as they choose. Consequently, some operators tag their websites with popular search terms that are neither relevant nor appropriate, because by doing so, they may attract additional consumer attention at little or no marginal cost. In addition, many websites have similar or identical tags, and automated search technology is generally not equipped to prioritize results in accordance with consumers' preferences.

Third, the multi-service portals' objective to retain the consumer and thereby realize additional advertising revenue is in direct conflict with the consumer's usual desire to efficiently locate relevant information, products, and services. As a result of this conflict and the difficulties that multi-service portals are encountering as the number of websites continues to grow, consumer searches now frequently generate hundreds, and often even thousands of results, many of which are not relevant to the consumer.

Moreover, search engine service websites, including multi-service portals, traditionally have not provided advertisers an audience that maximizes the effectiveness of the advertising dollar. To date, Internet advertising has primarily taken the form of banner or sponsorship advertisements which, like traditional media advertising, are typically priced according to advertisers' exposure to potential consumers. This approach, which is called impression-based advertising, translates into proportionally few actual customers. Advertisers effectively pay search service websites for exposure to viewers who are not interested in the product or service advertised. In response, many advertisers have concluded that portals do not represent an effective Internet advertising solution.

In sum, a conventional search generates an overwhelming amount of irrelevant data that is interspersed with the search results of interest. At the same time, the diffusion of consumer attention across the Internet, the concentration of online advertising on large websites, and the pricing of Internet advertisements on an impression basis with significant minimum expenditure requirements has made it increasingly difficult for advertisers to cost-effectively reach targeted markets on the Internet. Therefore, consumers' needs and advertisers' desires to meet those needs often go unmatched.

The problems encountered by online users and merchants with traditional search engines and directories has created an opportunity for another model for enabling users to locate information including contacting sellers and providers of goods and services. This model is the “Bid-for-Rank” or “Pay-Per-Click” search engine. Currently, the most popular engine in this category is Goto.com®, which enjoys a substantial market share among providers of Internet search services.

The core of any Bid-for-Rank search engine is that it puts much of the control of the indexing and presentation of search results into the hands of the online merchants and content providers. The Bid-for-Rank search engine allows website owners to control an extent their position in a display of search results to a user through an open market bidding process that charges the website owner only when a customer actually visits its website. The highest bidder's site preferably appears at the top, with others ranked below, displayed in descending order.

Most Bid-for-Rank search engines, however, suffer from the same editorial lag as directories. Initial accounts must be established, credit cards approved, and then a search engine editor must approve all keyword bids. Webmasters who want priority positioning for their websites must watch their keyword listings carefully, and then update their bids as changes to the listings occur. This task is made even more frustrating because some search engines require a long time (e.g., a week or more) to change rankings after new bids are submitted. This lag time, along with the need to explicitly provide updates to bids because of bidding by other merchants, steals much of the control from merchants that the Bid-for-Rank search engines may have intended to provide.

A need therefore exists for a system which enables webmasters and/or website owners to more easily control their position in a Bid-for-Rank search engine, without demanding that the webmaster constantly monitor the marketplace search engine. A need further exists for enabling advertisers to direct their advertising to search engine users that are potentially interested in the advertiser's content, products and/or services.

### SUMMARY OF THE INVENTION

The invention generally provides, in one aspect, computer-based systems and methods for providing search results to consumers along with advertisements or offers, and in a further aspect, for automatically generating targeted lists of customers and consumers.

In accordance with one embodiment as described herein, a targeted list of customers and consumers is derived through a series of communications initiated when a consumer utilizes a search engine. The search engine initially receives search criteria (e.g., a keyword) from a customer as part of a request for content related to the search criteria. The search engine obtains and transmits the search results to the customer and then transmits to the customer an invitation to be included in the target list related to the search criteria. The marketplace search engine then receives from the customer an acceptance of the invitation to be included in the target list, where the acceptance includes contact information for the customer. The engine addresses the request using the contact information and then transmits a confirmation request. Preferably, the search engine receives a confirmation of the acceptance from the customer; and then adds the contact information for the customer to the targeted list related to the search criteria. Alternatively, or in addition, the search engine serves to the customer an advertisement, such as a banner advertisement, related to the entered search criteria.

In another aspect, computer-based systems and methods are provided for automatically purchasing and/or selling advertising over a distributed communications network, such as the Internet. In accordance with one embodiment as described herein, a merchant seeking to purchase advertising transmits a keyword from a terminal to a marketplace search engine, where the transmitted keyword is preferably representative of the merchant's business. The merchant then receives at the terminal a list of advertisements related to the keyword. Preferably, the received advertisements are ordered in the list according to a pay price for each advertisement. The merchant then enters and transmits a bid price for a particular advertisement to the marketplace search engine. In response, the merchant receives a modified list of advertisements, where the merchant's advertisement is inserted into the list in accordance with the ordering according to the pay price.

Further embodiments, variations and enhancements are also described herein or depicted in the accompanying drawings.

### BRIEF DESCRIPTION OF THE DRAWINGS

FIG. 1 is a top-level diagram of an auction-based consumer-to-merchant connection system in accordance with a preferred embodiment as disclosed herein.

FIG. 2 is a block diagram illustrating a preferred embodiment of a search engine system as depicted in FIG. 1.

FIG. 3 is a diagram illustrating data type and storage details for the search engine databases shown in FIG. 2.

FIG. 4 is a flow diagram illustrating basic steps in a preferred method for facilitating communication between a merchant and a targeted consumer, such as may be performed, for example, with the system characterized by FIGS. 1-3.

FIG. 5 is a flow diagram illustrating basic steps in a preferred method for providing auction-based advertising for merchants in real-time, such as may be performed, for example, with the system characterized by FIGS. 1-3.

FIG. 6 depicts a flow diagram illustrating a more detailed method than that shown in FIG. 4 for facilitating communication between a merchant and a targeted consumer, such as may be performed, for example, with the system characterized by FIGS. 1-3.

FIG. 7 depicts a flow diagram illustrating detailed steps in a preferred method of providing consumers an opportunity to participate in an interest group, such as may be provided, for example, by the system characterized by FIGS. 1-3.

FIGS. 8A-C depict a flow diagram illustrating detailed steps in a preferred method of providing auction-based advertising for merchants in real-time, such as may be provided, for example, with the system characterized by FIGS. 1-3.

FIG. 9 depicts a screenshot of an HTML page serving as an example of what may be displayed to a customer accessing a website affiliated with an auction-based search engine system as described herein.

FIG. 10A depicts a screenshot of an HTML page serving as an example of the presentation of search results that may be displayed to a user on a distributed electronic network-based system in response to the user submitting a keyword from the website of an affiliate of the auction-based search engine system as described herein.

FIG. 10B depicts a screenshot of an HTML page serving as an example of search results that may be displayed to a user on a distributed electronic network-based system in response to the user submitting a keyword from the website of a branded affiliate of the auction-based search engine system as described herein.

FIG. 11 depicts a screenshot of an HTML window serving as an example of a login window for merchants accessing an auction-based search engine system as described herein.

FIG. 12 depicts a screenshot of an HTML window serving as an example of merchant profile entry, editing, and statistics display screen in connection with an auction-based search engine system as described herein.

FIG. 13 depicts a screenshot of an HTML window serving as an example of a keyword profile summary screen in connection with an auction-based search engine system as described herein.

FIG. 14 depicts a screenshot of an HTML window serving as an example of a merchant account summary screen in connection with an auction-based search engine system as described herein.

### DETAILED DESCRIPTION OF THE PREFERRED EMBODIMENTS

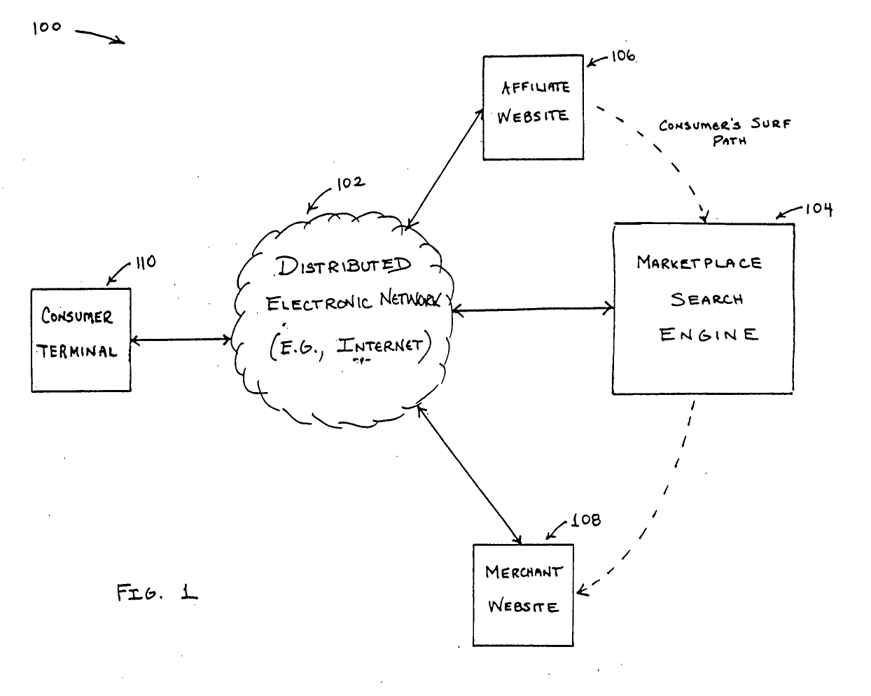

FIG. 1 is a top-level diagram of a preferred embodiment of an auction-based commerce facilitation system 100. The system 100 preferably operates across a distributed communications network 102, such as the Internet. Preferably electronically connected to the network 102 are a marketplace search engine 104, a consumer (or other user) terminal 110, an affiliate website 106 and a merchant website 108. As used herein, a merchant website 108 may be any website that advertises its location by being listed in the search results page provided to consumers in response to a search query. Typically, the merchant website 108 offers goods and/or services, or presents other content. Moreover, in connection with a merchant website, a “merchant,” as used herein, refers to a decision-maker for the merchant website regarding the merchant website's use of and/or involvement with the commerce facilitation system 100. For example, the merchant may be a webmaster, a website owner, or a merchant, as the term is commonly used. In a preferred embodiment, the system 100 comprises many consumer terminals 110, affiliate websites 106 and merchant websites 108 that are each connected to the distributed communications network 102.

The consumer terminal 110 in the system 100 may be any device for receiving and presenting data to a consumer, customer or other user (i.e., consumer) of the system 100, and for enabling a consumer to enter and transmit data. The consumer terminal 110 preferably first includes a processor for executing software-based application programs, a memory, and an electronic connection to the distributed communications network 104. The consumer terminal 110 may be any convenient type of computer, and preferably has processing characteristics dependent upon, for example, the real-time processing requirements of the software applications that are executed to facilitate and engage in the communication across the network 102. The consumer terminal 110 may comprise, for example, a workstation such as is manufactured by Sun Microsystems®, a main frame computer, a personal computer such as the type manufactured by IBM® or Apple®, a personal data assistant (PDA), an Internet telephone, or any other device that may communicate via a distributed electronic network. The processor is preferably configured to execute software (versus a completely hard-wired processor), due to the utility and flexibility in programming the processor and potentially, modifying or substituting the software. More generally, the processor may be implemented using any type of processor or processors that may perform the communication-related functions as described herein. Thus, as used throughout, the term “processor” refers to a wide variety of computational devices or means including, for example, using multiple processors that perform different processing tasks or have the same tasks distributed between processors. The processor(s) may be general purpose CPUs or special purpose processors such as are often conventionally used in digital signal processing systems. Further, multiple processors may be implemented in a server-client or other network configuration, as a pipeline array of processors, etc. Further, some or all of the processing is alternatively implemented with hard-wired circuitry such as an application-specific integrated circuit (ASIC), a field programmable gate array (FPGA) or other logic device.

In conjunction with the term “processor,” the term “memory” refers to any storage medium that is accessible to a processor that meets the memory storage needs for a system or system component for facilitating the functional aspects described herein. Preferably, the memory in the consumer terminal includes a random access memory (RAM) that is directly accessed by the processor. Preferably, the memory further comprises a hard disk or other non-volatile memory device or component for storing user identification data and executable files for the software application programs.

To facilitate the input and output of data to the user of the consumer terminal 110, the consumer terminal 110 preferably also includes a display, a keyboard, and a mouse. The display is preferably a monitor or other electronic viewer such as, for example, a cathode ray tube (CRT) or liquid crystal display (LCD), for displaying text and visual data. The mouse and the keyboard serve as data input devices for entering text and for controlling the various functions and selecting the various options presented by the software application programs executed in the processor. The communication between components of the consumer terminal 110 may be via any convenient protocol for communication between electronic components, such as Universal Serial Bus, PCMCIA card, PCI card, SCSI, FireWire, and Personal Communication Network (PCN).

The software applications executed by the processor preferably include a web browser. The web browser (e.g., Microsoft™ Internet Explorer™) provides the consumer terminal 110 with a software interface to the call-facilitating website 102, and facilitates the display of data to and entry of data by a consumer.

The affiliate and merchant websites 106, 108 typically each include one or more processors with memory (e.g., web servers) for handling communications over the network 102. Preferably, the web servers at the websites 106, 108 are connected to one or more other processors with memory (e.g., database servers) that preferably store content for the websites 106, 108.

Preferably, also connected to the network 102 is the marketplace search engine 104 that facilitates activity, preferably commercial, between a consumer operating from the consumer terminal 110 and the merchant operating from the merchant website 108. As shown in FIG. 1, the communication path that the marketplace search engine 104 preferably facilitates preferably presupposes that the consumer terminal 110 has initially accessed the affiliate website 106. In alternative embodiments, the consumer may directly access the marketplace search engine to perform search without going through an affiliate website 108. In a preferred embodiment, however, a search engine function appearing at the affiliate website 110, if engaged by the user at the consumer terminal 110, transfers the user to the website of the marketplace search engine 104. Search results that are presented to the user at the consumer terminal 110 preferably list advertisements of merchants, preferably ordered from top to bottom based on the amount paid for the advertisement. Each advertisement preferably includes Universal Resource Locator (URL), a link to an associated merchant website 108. By clicking on a particular advertisement, the consumer terminal communicates with the merchant website 108, and the user is thereby made aware of the content, products and/or services offered though the merchant website 108.

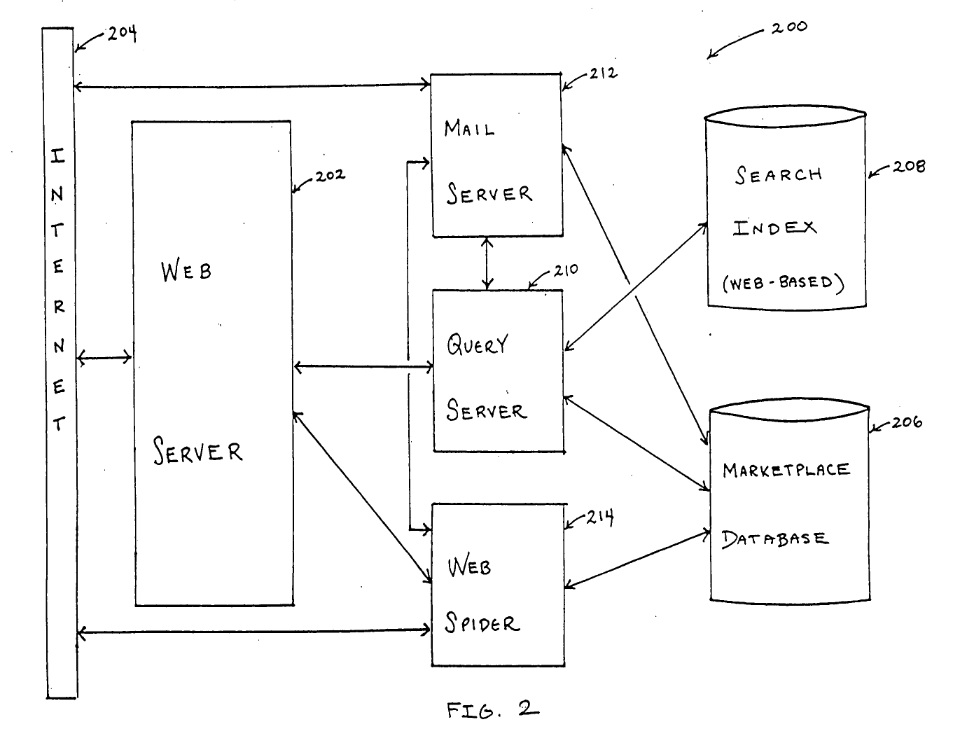

FIG. 2 is a block diagram illustrating a preferred embodiment of a marketplace search engine 200 (or 104) as represented in FIG. 1. The marketplace search engine 200 (or 104) preferably includes a web server 202 connected to a distributed communications network 204 (or 102). The marketplace search engine 200 (or 104) preferably also includes a mail server 212, query server 210, a web spider 214, a search index database 208, and a marketplace database 206. The servers 202, 210, 212 and web spider 214 each preferably include a processor and memory, such as a local memory cache, for performing functions preferably specialized for each server. Preferably, the web server 202, the mail server 212, and web spider 214 each further include a communication port for communicating across the communications network 204 (or 102), and execute an HTTP, HUTPS, UDP or other communications protocol interface to the communications network 204 (or 102). The web-based search index 208 and the marketplace database 206 each preferably are implemented as a database server, such as an Oracles database, for storing Hypertext Markup Language (HTML) data and/or other content. The web server 202 preferably also includes a CGI-type of communications interface to the query server 210. The query server 210 also preferably includes a communications interface to the search index 208, the marketplace database 206 and the web server 202. The query server 210 preferably processes requests originating from the consumer terminal 110, and optionally, from the mail server 212. Preferably, the requests are for links (i.e., URLs) to content related to one or more search terms comprising the request. The web server 202 forwards the requests to the query server 210. The query server 210 then retrieves the requested search results from the search index 208 and the marketplace database 206.

The search index 208 and the marketplace database 206 generally both provide search results based on a search request from the query server 210. The search index 208 preferably is an electronic index such as would be generated by a conventional search engine, and used to efficiently locate Internet content. The marketplace database 206 preferably contains data related to listings for and management of a Bid-for-Rank search engine.

The web spider 214 preferably includes electronic connections to the distributed communications network 204 (or 102), the web server 202, the marketplace database 206 and the mail server 212. The web spider 214 preferably performs a function of verifying data that is provided to the marketplace search engine by online merchants. The results of that verification may result in the performance of functions that are handled by the marketplace database 206, the mail server 212, and/or the web server 202. The mail server 212 preferably handles any e-mail communications that performed between the marketplace search engine 200 (or 104) and consumers and/or online merchants.

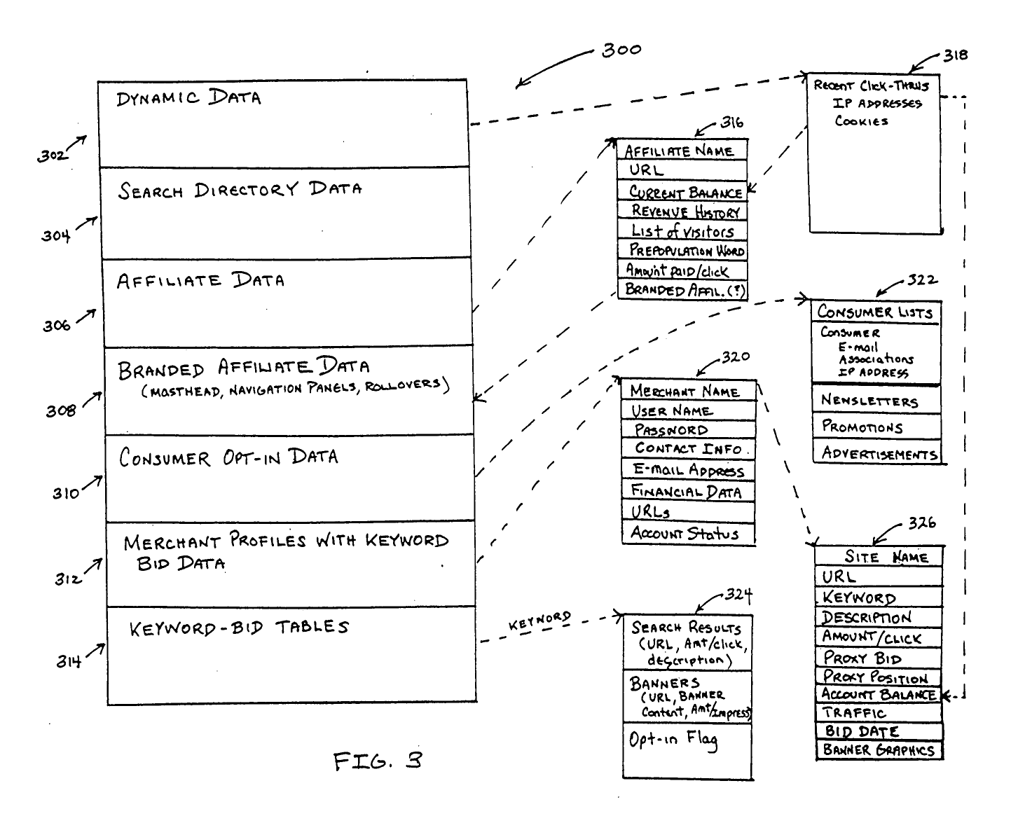

FIG. 3 is a diagram illustrating data type and storage details for the search engine databases 300 (or 206, 208) shown in FIG. 2. Generally, the databases 300 for the marketplace search engine 200 (or 104) preferably comprise dynamic data 302, search directory data 304, affiliate data 306, branded affiliate data 308, consumer opt-in data 310, merchant profile and bid data 312, and keyword-bid tables 314. The dynamic data 318 preferably comprises recent click-through data 318 on consumers that have accessed the marketplace search engine 200 (or 104), and/or hyper-linked to merchant websites from the marketplace search engine 200 (or 104). Such click-through data 318 may include Internet Protocol (IP) addresses and/or cookies for the consumer terminals 110 operated by the consumers and timestamps. The search directory data 304 preferably comprises the index data of a conventional search engine including a keyword index, associated URLs, and text descriptions of the content located at the listed URLs.

The affiliate data 306 preferably relates to the affiliate websites 106 that may channel the consumers to the marketplace search engine 104. The affiliate data 306 preferably includes fields. 316 for an affiliate name, affiliate URL, a current account balance, a revenue history, and a list of consumers that have been channeled by the affiliate to the marketplace search engine 200 (or 104). The affiliate data 306 preferably also includes any “prepopulating” keyword that the affiliate prefers to have as a default keyword for consumer searches, the amount that is paid to the affiliate per click-through to the marketplace search engine 200 (or 104), and whether the affiliate is classified as a “branded” or “standard” affiliate.

Branded affiliates represent affiliates of the marketplace search engine 200 (or 104) for whom the-look-and-feel (website trade dress, trademarks, color palette, etc.) of the search results provided to the user by the marketplace search engine 200 (or 104) are the same or similar to those of the affiliate website 106. For such affiliates, additional affiliate data (i.e., branded affiliate data 308) is stored. Branded affiliate data 308 preferably includes HTML data that describes the presentation of a web page such as mastheads, navigation panels, and rollovers.

The consumer opt-in data 310 preferably is data used to characterize and manage a process by which consumers may be added to mailing or group lists that are tailored to particular areas or subjects of interest. As such, consumer opt-in data 310 preferably includes data comprising lists of consumers (e.g., names, email addresses, IP addresses, and target list associations), newsletters, promotions, and advertisements.

The merchant profile and bid data 312 comprises data used to characterize-and manage the merchant websites 108 that are advertised by the marketplace search engine 200 (or 104) by being included in the search results associated with particular keywords that are displayed to consumers. The merchant profile and bid data 312 first includes a set of profile fields 320 that relate to general information about a merchant website 108. Data in the profile fields includes merchant names, user names and passwords for access to the marketplace search engine 200 (or 104), contact information (e.g., mailing addresses and phone numbers), e-mail addresses, financial data (e.g., credit card data, account data), URLs, and account statuses. The merchant profile and bid data 312 also includes bid fields 326 to describe particular bids placed by individual merchants. The bid fields 326 comprise data that preferably includes a website name, a URL, a keyword, a text or other description of the website, and an amount paid per click by the merchant to the marketplace search engine 200 (or 104) for click-throughs by consumers. Preferably, the bid fields 326 further include a proxy bid that specifies a maximum that a merchant is willing to pay for a click-through to retain a particular position in the search results, an account balance for that particular advertisement, and the amount of consumer traffic that the advertisement has generated. Further, the bid fields 326 preferably include the date that the bid was placed by the merchant, and any graphics associated with an advertisement banner that may displayed in the first or other pages of search results to the consumer.

The marketplace database 300 further comprises keyword-bid tables 314, where a table is provided for each keyword represented in the marketplace database 206. The keyword-bid tables preferably provide fields 324 for Bid-for-Rank search results (i.e., a URL, a description of a merchant website, and an amount paid per click by the merchant website) that are displayed to a consumer for each keyword that is represented in the database 300. The keyword-bid tables 314 preferably further provide fields 324 for banner data related to a particular keyword including a URL, a graphic (e.g., GIF or JPEG file), and an amount paid per impression associated with each banner. Further, the keyword-bid tables preferably provide a flag to specify whether an opt-in program exists associated with the keyword to attract consumers to a listing associated with a particular interest area.

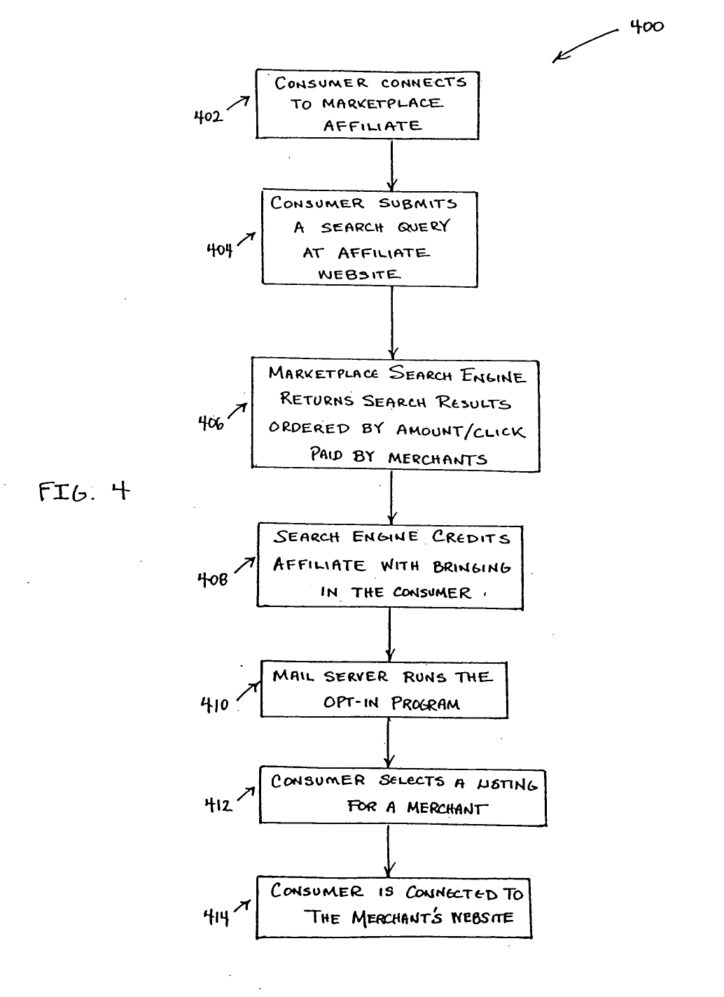

FIG. 4 is a flow diagram illustrating basic steps in a preferred method 400 for facilitating communication between a consumer and content provider or a seller of goods and/or services (i.e., merchant), such as may be performed, for example, with the system 100 characterized by FIGS. 1-3. In a first step 402 in the method 400, a consumer using a consumer terminal 110 connects to an affiliate website 106 of the marketplace search engine 104. The affiliate website 106 is one that the consumer has preferably connected to because of past usage of the affiliate website or because the consumer has otherwise become aware of the website 106.

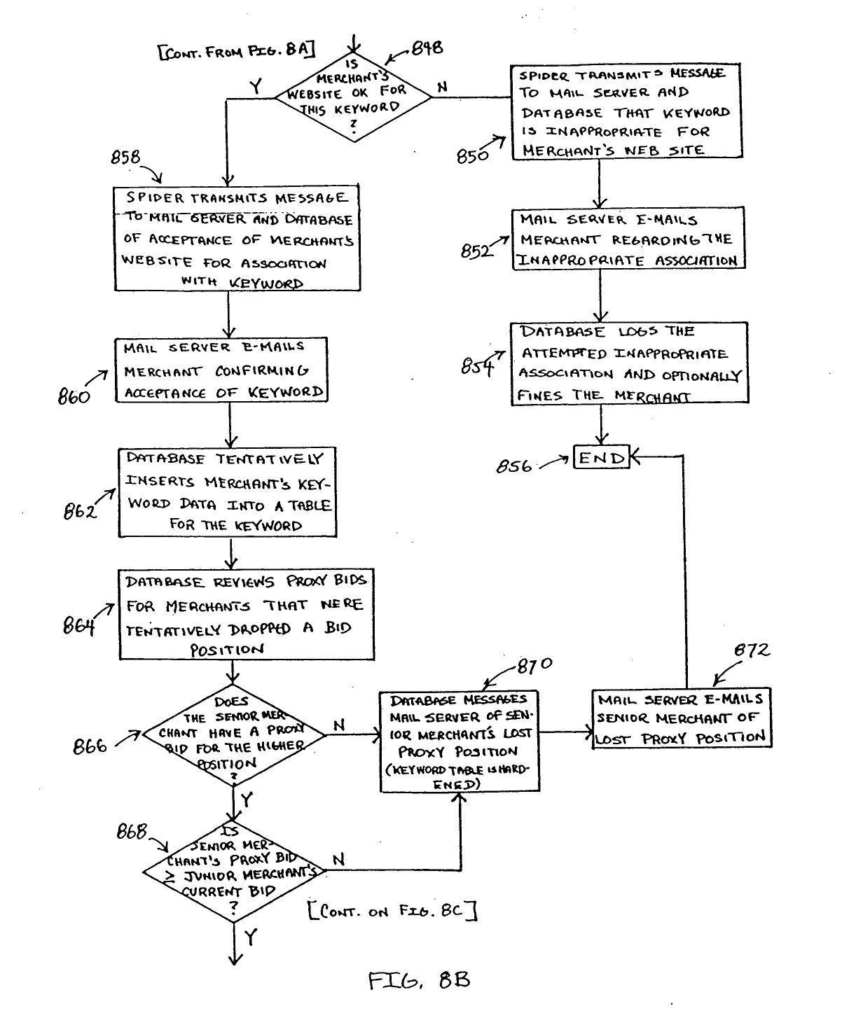

In a next step 404, the consumer preferably submits a search query at the affiliate website 106. Preferably, the consumer enters search criteria comprising one or more keywords to form the search request. Alternatively, the consumer enters the query in a natural language form, that may then be parsed into a Boolean query by the query server 210 once received at the marketplace search engine 200 (or 104). FIG. 9 depicts a screenshot of an Hypertext Markup Language (HTML) page serving as an example of what may be displayed to a customer accessing an affiliate website 106. As shown in FIG. 9, the HTML page 900 returned to the consumer terminal by the affiliate website 106 includes a search box with a text field to allow for the entry of a request. In FIG. 9, the text field has been prepopulated by the keyword “cars.” The search box also includes a “click here” button to enable the consumer to submit the request to the marketplace search engine 200 (or 104).

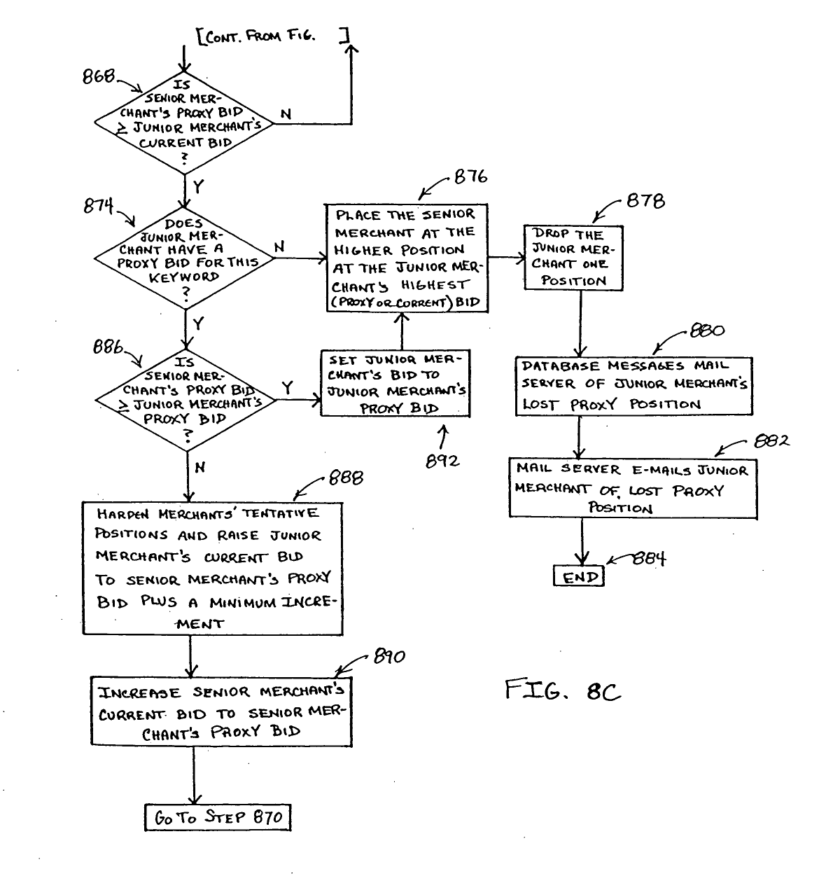

In a next step 406, the marketplace search engine 200 (or 104) preferably returns to the consumer's terminal 110 an HTML page comprising search results for the keyword that the consumer submitted. FIG. 10A depicts a screenshot of an HTML page serving as an example of the presentation of search results that may be displayed on a consumer terminal 110 in response to the consumer submitting a keyword using a webpage from an affiliate website 106. As shown in FIG. 10A under “PREMIUM LISTINGS,” the results preferably include Bid-for-Rank results that are ordered by the amount paid by the merchants if the consumers click through a result to hyper-link to the merchants' websites 108. Preferably, below the Bid-for-Rank search results are listings that may be provided by a conventional search engine that continually indexes the Internet.

Where the affiliate to the marketplace search engine 200 (or 104) is a branded affiliate, the returned HTML page preferably has the trade dress, trademark, color palette and/or look of the affiliate website 106. FIG. 10B depicts a screenshot of an HTML page serving as an example of search results that may be displayed to a consumer on a consumer terminal 110 in response to the consumer submitting a keyword from a branded affiliate website. In the example, the results returned are preferably the same as those returned by the standard affiliate website. However, the HTML page has the trade dress and has the look of the affiliate. To the consumer, the returned HTML page preferably looks like it originated from the affiliate website 106.

Preferably, while the marketplace search engine 200 (or 104) is transmitting search results to the consumer terminal 110, or shortly thereafter, the marketplace search engine 200 (or 104), in a next step 408, credits the account of the owner of the affiliate website 106 that transferred the consumer to the marketplace search engine 200 (or 104) via the search query. This credit may be a few cents or more, and preferably applies to customers that have not recently accessed (e.g., within one hour) the marketplace search engine 200 (or 104).

In a next step 410, where a group, organization, newsletter, advertising campaign, promotion and/or other electronic message to consumers is associated with the keyword entered by the consumer, the mail server 212 at the marketplace search engine 200 (or 104) preferably administers a process of offering the consumer an opportunity to voluntarily enter an opt-in program. Preferably, the mail server 212 transmits an email to the consumer terminal 110 at the same time or shortly after (e.g., within 30 seconds) the web server 202 for the marketplace search engine 200 (or 104) has transmitted the search results to the consumer terminal 110. The mail server 212 invites the consumer to participate in any program that has been established to inform the consumer on a subject related to the keyword entered by the consumer.

In a next step 412, the consumer selects a listing representing a merchant website 108 from the search results displayed on the returned HTML page. Preferably, by clicking a mouse on the listing, the consumer submits a URL for the merchant website 106. Then, in a next step 414, the consumer receives the HTML web page with the associated URL. At the same time, the marketplace search engine 200 (or 104) preferably retrieves information regarding the consumer's access to the merchant website 108. The consumer is thereby effectively communicating with the merchant, and preferably, because of the specific subject-oriented actions taken by the consumer, is considered a targeted customer for the merchant.

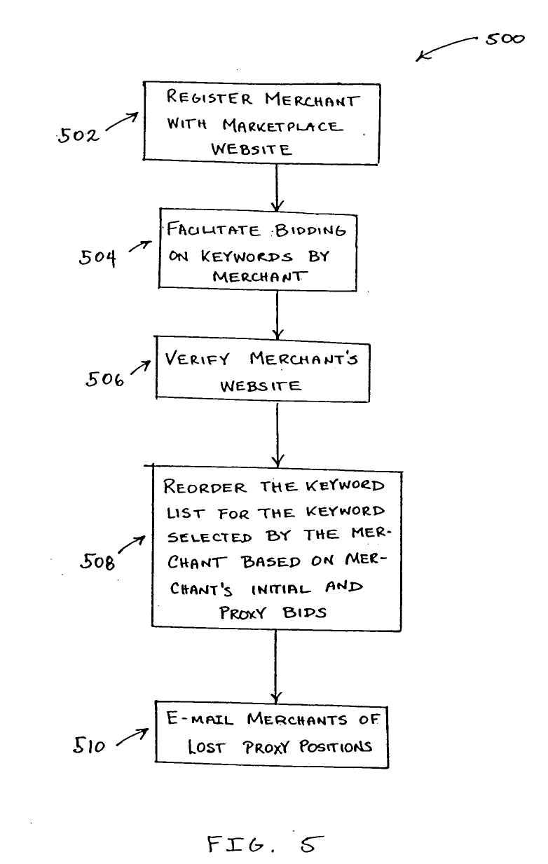

FIG. 5 illustrates basic steps in a preferred method 500 for providing auction-based advertising for merchants in real-time, such as may be performed, for example, with the system characterized by FIGS. 1-3. In a first step 502 of the method 500, a merchant registers with the marketplace search engine 200 (or 104). Preferably, this process comprises aiding the merchant in setting up an account, including requesting basic information such as is listed in the merchant profile fields 320 discussed above. Once a merchant has registered with the marketplace search engine 200 (or 104), the marketplace search engine 200 (or 104) facilitates a step 504 of having the merchant bid on keywords of interest. The keywords selected are those that when entered by a consumer result in a description of the merchant's website being displayed to the consumer, and in a position on the search results page that is dependent on the bid amount specified by the merchant.

Preferably, in addition to including an initial bid on each keyword, the merchant also submits one or more proxy bids associated with the keyword. The proxy bid represents a monetary amount, typically exceeding the initial bid, that the merchant is willing to pay to maintain a particular position, a position that is preferably specified by the merchant, in the search returns for the specified keyword. Alternatively, the merchant may submit different proxy bids for different positions in the search results. When this amount is specified, the marketplace search engine 200 (or 104) may increase the merchant's bid for a particular keyword from the initial bid up to the proxy bid without requiring any additional authorization from the merchant. The merchant, however, preferably is notified via email of the increase in the actual amount charged for a click-through by a consumer.

Once the merchant has bid on and submitted one or more keywords, in a next step 506, the merchant website 108, that is the advertising target for the keyword, is verified. In this step 506, the marketplace search engine 200 (or 104) preferably accesses the merchant website 108 to determine the whether keywords specified by the merchant, in fact, have some relationship to the content, goods, and/or services offered by the merchant website 108. If no relationship can be established, such as by a comparison of the keyword to the text on the HTML page, then the marketplace search engine 200 (or 104) may reject the bid from the merchant for that keyword and not enter the merchant's bid and website in the results listing for that keyword.

In a next step 508, if the merchant website 108 has been verified for each keyword for which the merchant submitted a bid, the listings for each keyword selected by the merchant are reordered based upon the merchant's initial and proxy bids. “In this step 508, the proxy bids for other merchants that have bids on the same keyword are preferably examined to determine the proper ordering of the keyword listing, given the additional initial and proxy bids by the newcomer (i.e., junior) merchant.

Then, in a next step 510, to the extent that any merchants that are listed for the keyword have their positions in the search results and/or bid amounts affected by the bids from the junior merchant, these merchants are preferably notified by an email of the change in status and the details of that change.

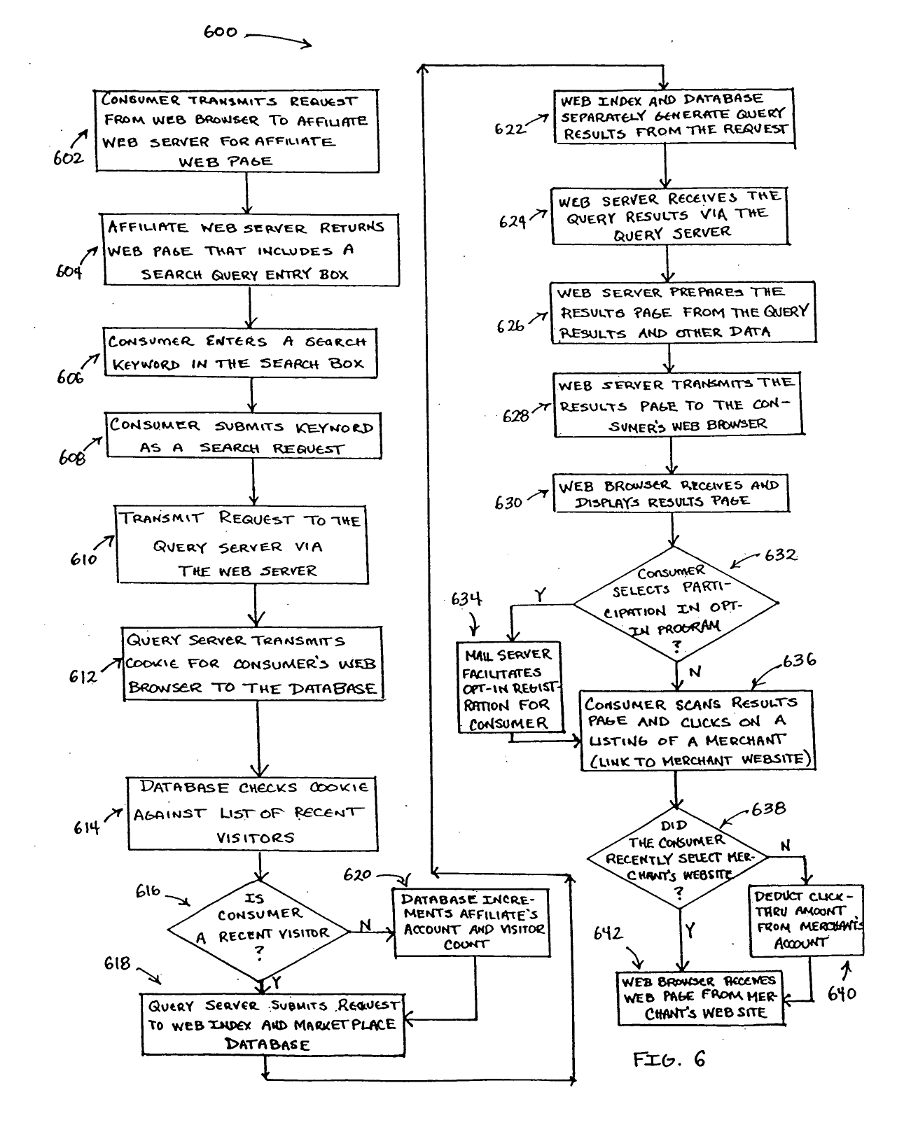

FIG. 6 depicts a preferred embodiment of a detailed method 600 for facilitating communication between a merchant and a targeted consumer, such as may be performed, for example, with the system characterized by FIGS. 1-3. In a first step 602, a user operating from a consumer terminal 110, preferably employs a web browser to transmit via Hypertext Transfer Protocol (HTTP), or other communications protocol, a request to an affiliate web server for an HTML web page from the affiliate website 108. Alternatively, the request is directly transmitted to the marketplace search engine 200 (104), in which case the consumer is already aware of the marketplace search engine 200 (or 104) and is explicitly seeking to perform a search. However, in the case where the consumer is connected to an affiliate website 108, then in response to this request, the affiliate website 108, in a next step 604, preferably returns via HTTP an HTML webpage to the web browser operating from the consumer terminal 110. Preferably, the HTML page includes a graphic box with a text entry field and is labeled to indicate to the consumer that search queries may be performed by entering keywords in the search box. In one embodiment, the search box is prepopulated with a keyword that relates to the subject matter of the affiliate website 108.

Then, in a next step 606, the consumer enters a keyword or keywords in the text field of the search box. Preferably, the consumer uses a user-input device such as a keyboard or microphone to enter the search request. In a next step 608, the consumer submits the search request. Preferably, the consumer does so by pressing “Enter” on the keyboard or by clicking a “Submit” or other button using a mouse. This act preferably initiates an HTTP transmission of the keyword search request to the marketplace search engine 200 (or 104). The web server 202 of the marketplace search engine 200 (or 104) preferably receives the request, acting as a communications interface for the marketplace search engine 200 (or 104) with the web browser at the consumer terminal 110.

In a next step 610, the request is preferably reformatted and transmitted by the web server 202 to the query server 210. The query server 210 preferably controls the extraction of search results from the search databases 206, 208 and the transmission of the search results to the consumer.

Preferably, included in the transmission of the search request from the consumer terminal 110 is a cookie that identifies the consumer terminal 110 to the marketplace search engine 200 (or 104). The query server 210 preferably receives the cookie from the web server 202 at the same time as the search request. Thus, in a next step 612, the query server 210 preferably transmits the cookie for the consumer's terminal 110 to the marketplace database 206. In a next step 614, the marketplace database 206 compares the cookie to its dynamic data 302 containing the cookies for recent (e.g., within one hour) visitors. Preferably, any cookie in the dynamic data 302 indicates a recent visitor because cookies are given a “time-to-live.” That is, after a certain period (e.g., one hour), the cookies are deleted from the dynamic data region 302. The marketplace database 206 thus tests for the condition 616 of whether the consumer is in fact a recent visitor, preferably by looking for the same cookie in the dynamic data 302. If the consumer is not a recent visitor, then in a next step 620, the marketplace database 206 preferably increments the affiliate's account by an amount previously agreed upon (e.g., five cents) between the affiliate and the manager or owner of the marketplace search engine 200 (or 104). If the consumer is considered a recent visitor, then preferably no such increment to the affiliate's account is performed. In either case, the cookie is preferably refreshed in the dynamic data 302.

In the next step 618, the query server 210 preferably submits the request to both the Internet search index 208 and the marketplace database 206. In a next step 622, the Internet search index 208 and the marketplace database 206 each separately generate search results from the received request. The search index generates results from an index compiled by scouring the Internet by a crawler (not shown). The marketplace database 206 produces the up-to-date Bid-for-Rank listings that are associated with the keywords in the request. In a next step 624, the query server 210 forwards the results from both databases 206, 208 to the web server 202. If results from only one database are produced, then the query server 210 provides to the web server 202 only those results.

Preferably, if the marketplace database 206 produces search results, the database 206 preferably also returns one or more graphics (e.g., animated GIF files) of banners for display on the consumer's web browser along with the search results. Preferably, the banners are associated with the search results in that they topically relate to the consumer's search query. Further, the displayed banner(s) preferably are associated with one or more of the merchant websites that are presented in the search results. In one embodiment, a single banner is returned to the query server 210 by the marketplace database 206, and represents the banner advertisement provided by the merchant with the highest amount paid per click-through for the specified keyword. In another embodiment, multiple banners are returned to the query server to present a cycling of several banner advertisements on the consumer's display.

In a next step 626, the web server 202 prepares the search results for transmission to the consumer terminal 110. The web server 202 preferably formats the results into one or more HTML pages. If the affiliate website 106 is a branded affiliate, then the web server 202 preferably also receives branded affiliate data 308 from the marketplace database 206 via the query server 210, which is then used to generate the layout for the HTML page that is transmitted to the consumer terminal 110. Applying the branded affiliate data 308 to the HTML page, the search results appear to the user to have been generated and transmitted from the affiliate website 108. Once the web server 202 has prepared the search results for transmission to the requesting web browser at the consumer terminal 110, the web server 202, in a next step 628, preferably transmits a first HTML web page, preferably via HTTP communication. Additional pages in the search results are preferably retained by the web server 202 and are transmitted only upon subsequent request by the web browser.

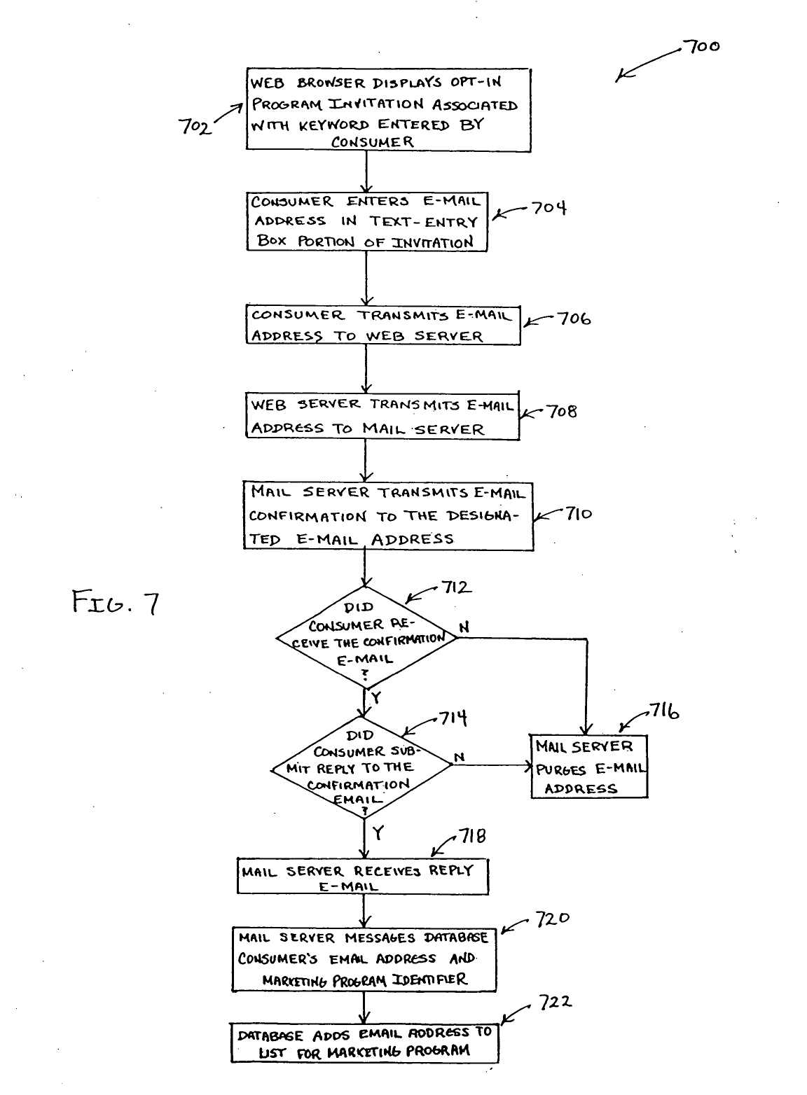

In a next step 630, the consumer terminal 110 receives and the web browser displays an HTML page of search results, including any graphics of banner advertisements, each of which preferably also provide a hyper-link to a merchant website 108. Preferably, also included in the search results page is a button or other prompt to enable the consumer to opt into a targeted group relating to keyword(s) specified in the consumer's initial search request- In one embodiment, the search result page includes prompts relating to multiple groups, promotions, and/or advertising campaigns in which the consumer may express an interest. Thus, the method 600 depends on the condition 632 of whether the consumer chooses to participate in one or more such subject-specific groups. If the consumer chooses to enlist in one or more groups by responding to a prompt, then a request is sent to the marketplace search engine 200 (or 104) that, in a next step 634, initiates an opt-in program initiation and verification process via an exchange of email. FIG. 7, as described below, details steps in a preferred method of providing consumers an opportunity to participate in an opt-in program.

After the opt-in registration is completed, if the consumer decides not to participate, or if no opt-in program opportunity is available for the specified keyword(s), the consumer, in a next step 636, preferably scans the displayed search results page and clicks on a listing of a merchant website 108. This step 636 initiates a request to link to a specific URL at the merchant's website 108. Preferably, while the request for HTML page of the merchant website 108 is in process, information regarding the request (i.e., the cookie for the consumer terminal and its merchant website destination) is transmitted to the web server 202 for the marketplace search engine 200 (or 104). Alternatively, the request for the merchant website 108 is transmitted only to the marketplace search engine 200 (or 104), which forwards the request to the merchant website 108. The web server 202 preferably transmits data regarding the request (e.g., consumer ID, a timestamp, a requested merchant website destination) to the marketplace database 206. The marketplace database 206 then compares the request to the dynamic data 302, to test a condition 638 of whether the consumer has recently (e.g., within one hour) clicked through to the same or, alternatively, any other merchant website.

If the consumer has not recently clicked through to the particular merchant website, and, in an alternative embodiment, to any other merchant website, then, in a next step 640, a fixed monetary amount is deducted from the merchant's account for that keyword and a counter is incremented to indicate a new visitor to the merchant website via the marketplace search engine 200 (or 104). After the deduction from the merchant's account or if the marketplace database 206 determines that the consumer recently clicked through to the merchant's website 108, then, in a next step 642, the web browser at the consumer terminal 110 receives the requested web page from the merchant website 108. This step 642 establishes the initial contact between the consumer and the merchant, completing a process 600 of connecting two parties, and in a specific embodiment, of commerce facilitation.

As noted above, FIG. 7 details steps in a preferred method of providing consumers an option to participate in and/or subscribe to an interest group. In a first step 702, preferably as part of a return of search results to the consumer in response to a search query, the web server 202 transmits an invitation to the consumer to participate in an opt-in program associated with the keyword(s) that the consumer entered. This invitation preferably includes text describing the nature of an interest group and/or mailing list, and preferably invites the user to click a displayed button or otherwise indicate interest in joining the group and/or list. Preferably, the interest group or list is such that the user may periodically receive information via email or otherwise on a subject area that relates to the entered keyword(s). The invitation preferably also includes a text entry field to prompt the user to enter the user's email address. Thus, in a next step 704, the user preferably enters the user's email address in the text-entry box of the invitation.

Then, in a next step 706, the user transmits the email address to the web server 202, preferably by pressing “enter” on the keyboard or clicking on the button prompt with the mouse. This act represents an initial acceptance of the invitation to be included in the interest group, such that for example, the user would be included in a distribution list for information related to the area of interest. In a next step 708, the web server 202 receives the email address for the consumer and forwards the email address to the mail server 212, preferably via the query server 210 which preferably tentatively stores the email address. In a next step 710, the mail server 212 preferably transmits an email comprising a confirmation request to the email address provided by the consumer.

The next step of the preferred opt-in method 700 depends on a condition 712 of whether the consumer receives the email of the confirmation request. If the consumer does not receive the confirmation request, then in a next step 716, the mail server preferably purges the email address from memory. The query server 210 may also purge the email address or alternatively forward the email address to the marketplace database, potentially for future reference. The consumer, however, preferably is not added to the listing for the particular interest group. If, however, the consumer does receive the email of the confirmation request, then another condition 714 determines the next step. Preferably, that condition 714 is whether the consumer submits a reply (e.g., an autoreply) to the confirmation request. If no reply is sent, then the method 700 proceeds to step 716, wherein the email address is purged and the consumer is not added to the list for the interest group. If the consumer does submit a reply to the confirmation request, then in a next step 718, the mail server 212 receives the reply. Preferably, reception of the reply acts as a confirmation that the consumer is unequivocally interested in participating (e.g., receiving information, promotions, etc.) in the interest group.

If the mail server 212 receives the reply email, then in a next step 720, the mail server 212 initiates the transmission of the consumer's email address to the marketplace database 300 (or 206). At the database 300 (or 206), the email address of the consumer is added to the consumer list representing the consumer's interest group.

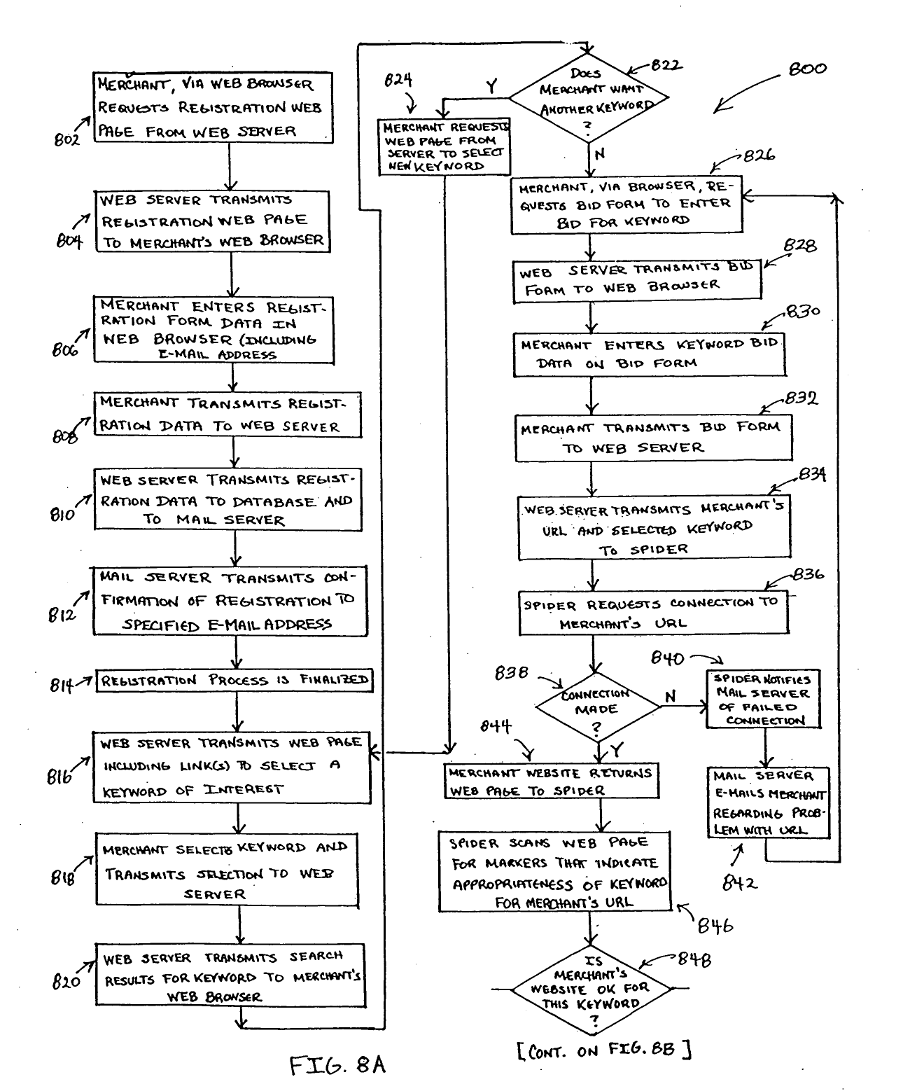

FIGS. 8A-C illustrate detailed steps in a preferred method 800 of providing auction-based advertising for merchants in real-time, such as may be provided, for example, with the system characterized by FIGS. 1-3. Turning first to FIG. 8A, in a first step 802, a merchant, website administrator, or other seeker of advertising for a website offering content, goods, and/or services (i.e., merchant) requests via a web browser a registration web page from the web server 202. The web server 202 receives the request for the registration web page and, in a next step 804 transmits the registration web page to the merchant's web browser. In a next step 806, upon receipt of the registration web page, the merchant enters registration form data in the text entry fields provided by the registration page. Then, in a next step 808, the merchant transmits the entered registration data to the web server 202. Preferably, in a next step 810, the web server 202 forwards the registration data to the mail server 212 and the marketplace database 206.

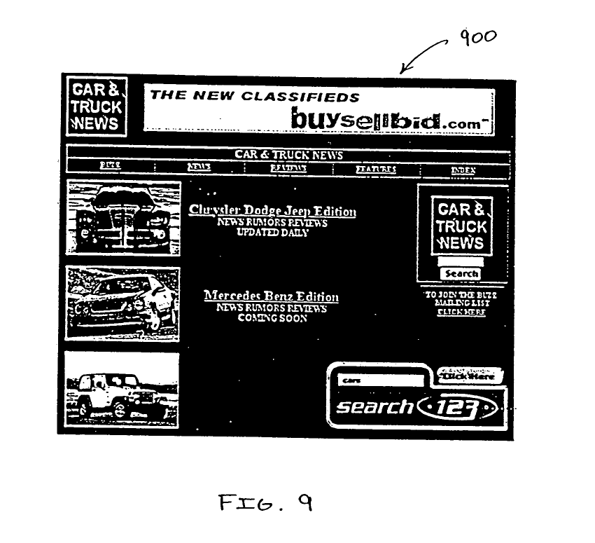

In a next step 812, the mail server 812 preferably transmits a confirmation of registration to the email address provided by the merchant in the submission of registration data. Preferably, in a next step 814, the registration process is finalized. This step 814 may be performed automatically via a confirmation email from the merchant, telephonically between a representative of the marketplace search engine and the merchant, or via any other convenient means. In concluding the registration process, the merchant preferably has established an account with the marketplace search engine 200 (or 104) including a user name and password. Once registered, the merchant preferably accesses a web page providing the merchant a window containing text entry fields to enter the merchant's user name and password, and enable access to the merchant's account information and perform various operations relating to bidding on and analyzing the performance of keywords. FIG. 11, for example, depicts a screenshot 1 100 of an HTML window providing a means for merchants to access private information stored in the marketplace search engine 200 (or 104).

In a next step 816, the web server 202 transmits a web page to the merchant's web browser enabling the merchant to select hyper-linked keywords or enter keywords that are of interest to the merchant. In a next step 818, the merchant selects or enters a keyword of interest and transmits the selection to the web server 202. Preferably, the keyword is among the most relevant keywords and phrases that might be used when a consumer searches for content, products and/or services like those offered by the merchant website 108. In response to the selection, in a next step 820, the web server 202 preferably transmits the search results for the keyword selected by the merchant to the merchant's web browser. The search results are preferably presented to the merchant in the same way as they appear to a consumer that entered the same keyword as part of a search request. Thus, the search results presented to the merchant are listings of websites, where each listing preferably comprises a title, a brief description, and an amount paid by the corresponding merchant if the consumer hyperlinks to the corresponding merchant's website.

Preferably, the merchant examines the search results for the keyword and determines, based on the content of the listings and the costs paid for each listing, whether or not to proceed to place a bid on the keyword. If the merchant prefers 822 to examine the search results for another keyword, then the next step 824 is that the merchant submits a request to the web server 202 to receive the web page for selecting a new keyword. If such is the merchant's preference, then in the next step 816, the web server 202 provides the web page. The method then preferably proceeds forward from this step 816.

If the merchant, however, determines to place a bid on the selected keyword, then in a next step 826, the merchant, via the web browser, requests a bid form to enter a bid for the keyword. In response to the request, the web server 202, in a next step 828, preferably transmits an electronic bid form to the merchant's web browser. The keyword bid form preferably includes text entry fields to enter the information that will appear in the search results including the title and the brief description of the content at the merchant website 108. The bid form preferably also provides text entry fields for the hyperlink (i.e., URL) when a consumer clicks-through on the title, and the amount that the merchant is willing to pay for each such click-through (i.e., initial bid). Preferably, the bid form also includes an entry field for a, preferably optional, proxy bid by the merchant. In a preferred embodiment, the bid form also includes a field for specifying the location of an electronic banner advertisement (e.g., GIF, animated GIF, or JPEG file) or for attaching the file for the banner, or any other convenient means for specifying a banner.

Thus, in a next step 830, the merchant preferably specifies a banner file and enters keyword bid data in each text entry field of the bid form, where the entered bid data preferably includes the title, brief description, the URL, the initial bid, and the proxy bid. Once the bid data is entered, then in a next step 832, the merchant transmits the bid data (and optionally the banner file) to the web server 202. Once received at the web server 202, the web server 202, in a next step 834, transmits the URL specified in the bid data to the web spider 214. The spider 214 provides an automatic mechanism for verifying the existence of a close relationship between the content at the specified URL and the keyword. Thus, in a next step 836, the web spider 214 preferably requests the data at the specified URL.

The next step is determined by a condition 838 of whether the web spider. 214 retrieves the data (e.g., HTML data) from the specified URL. If the data cannot be retrieved or a connection cannot be established, the web spider 214, in a next step 840 notifies the mail server 212 of the failed connection. Then, to inform the merchant of the failure, the mail server 212 retrieves via the query server 210 from the merchant profile 320 in the marketplace database 206 the email address for the merchant. The mail server 212, in a next step 842, then transmits an email to the merchant indicating the failure to retrieve any data using the specified URL. Preferably, in the next step, 826, the merchant requests the bid form again to specify a new URL for the keyword.

If, however, the web spider 214 does connect to the merchant website 108 via the specified URL, then in a next step 844, the merchant website 108 returns the data for the web page to the web spider 214. The web spider 214 then receives the data and scans the data for markers indicating the appropriateness of the keyword with respect to the merchant's web page and/or website. This process preferably includes scanning for terms that are inappropriate or normally censored. The process preferably also includes scanning for terms that are the same as, are synonyms of, or are specific instances of the keyword. Based on this analysis, the web spider 214 makes a determination of whether the website 108 is an acceptable reference for the specific keyword. Alternatively, the web spider 214 makes a preliminary determination that is then manually reviewed by a human editor for the marketplace search engine 200 (or 104). Further, the web spider 214 may alternatively gather data for the entire merchant website 108 rather than for a single web page as a basis for performing an assessment of the keyword's topical relationship to the merchant's website 108 generally. In another embodiment, the web spider 214 periodically gathers data from all of the URLs that are linked to search results in the marketplace database 206. By doing so, the marketplace search engine 200 (or 104) continually checks for the integrity and appropriateness of the websites (as they relate to their keywords) to which the marketplace search engine 200 (or 104) refers potential consumers.

Turning to FIG. 8B, the flow of the method 800 is based on the condition 848 of whether the merchant's website is determined to be an acceptable reference for the specified keyword. If the web page and/or website are determined to be an unacceptable reference for the keyword, then in a next step 850, then the web spider 214 preferably transmits a notification to the mail server 212 and the marketplace database 206 of the inappropriateness of the merchant's website 108 for the specified keyword. In a next step 852, the mail server 212 preferably emails the merchant of the inappropriate association. Further, in a next step 854, the marketplace database 206 preferably logs the attempted inappropriate association, and optionally, decrements the merchant's account as a fine. Along this alternative path in the method 800, a final step 856 is to terminate the overall process 800 of providing advertising to and/or obtaining advertising by a merchant.

Alternatively, if the merchant's website 108 is an acceptable reference for the specified keyword, then in a next step 858, the web spider 214 preferably transmits a notification to the mail server 212 and the marketplace database 858 of the acceptance of the merchant's website 108 for association with the specified keyword. Then, in a next step 860, the mail server 212 preferably generates and transmits an email to the merchant confirming the acceptance of the keyword by the marketplace search engine 200 (or 104). As a next step 862, the marketplace database 206 preferably transmits the keyword bid data and any banner file to the merchant's profile 320, 326, and tentatively inserts the merchant's keyword into the search result listings for the keyword. The entry is tentative because the effect of proxy bids by the new merchant (i.e., junior merchant) and other merchants (i.e., senior merchants) with listed bids for the keyword have not yet been accounted for. Thus, in a next step 864, the marketplace database 206 preferably reviews the proxy bids for the senior merchants that were tentatively dropped in rank due to the insertion of the junior merchant in the search result listing.

In the next step, the marketplace database tests a condition 866 for the highest ranked senior merchant that was dropped a position. The test is whether the senior merchant has a proxy bid in place in order to keep its original position. If the senior merchant has no such proxy bid, then in a next step 870, the marketplace database 206 preferably messages the mail server 212 of the senior merchant's lost proxy position. Furthermore, in this step 870, the tentative positioning of the merchants for the specified keyword is finalized (i.e., hardened). In a next step 872, the mail server 212 preferably transmits an email to the senior merchant of its drop in position in the search results for the keyword.

If the senior merchant does have a proxy bid in place to maintain its original position, then the next tested condition 868 preferably is whether the senior merchant's proxy bid is greater than or equal to the junior merchant's current bid. If the senior merchant's proxy bid is less than the junior merchant's current bid, then the effect is the same as the previous case. The marketplace database 206 hardens the listing, and initiates an email via the mail server 212 of the senior merchant's drop in position. After that set of steps 870, 872, the process 800, as a final step 856, preferably terminates.

Turning to FIG. 8C, if the senior merchant's proxy bid is greater than or equal to the junior merchant's current bid, then the marketplace database preferably proceeds to test a next condition 874 of whether the junior merchant has in place a proxy bid for the specified keyword. If the junior merchant does not have a proxy bid for the specified key word, then in a next step 876, the marketplace database 206 preferably returns the senior merchant to its original position, dropping the junior merchant one position in rank. Preferably, the bid amount for the senior merchant is adjusted to be the same, or alternatively, one monetary increment (e.g., one cent) greater than the junior merchant's current bid. Thus, in a next step 878, the junior merchant is dropped one position in the search results listing. In a next step 880, the marketplace database 206 preferably messages the mail server 212 of the junior merchant's drop in position. The mail server, thereby, in a next step 882, transmits an email to the junior merchant notifying the junior merchant of its drop in one position in the search results listings. In this case, the process 800, in a final step 884, preferably terminates.

As another alternative, if the junior merchant does have a proxy bid in place for the specified keyword, then the marketplace database 206 preferably tests yet another condition 886 of whether the senior merchant's proxy bid is greater than or equal to the junior merchant's proxy bid. If the senior merchant's proxy bid is greater than or equal to the junior merchant's proxy bid, then in a next step 892, the junior merchant's current bid is raised to its proxy bid, and the junior merchant is dropped one position in the search results listing. Although the junior merchant's position is dropped by one, the junior merchant's current bid is preferably raised to its proxy bid in order to avoid unfairness to the senior merchant who's bid is also raised to maintain its original position. Further, senior merchants are preferably given the benefit of a higher position in the search listing over junior merchants where the bids for the merchants are equal. Thus, in the next step 870, the senior merchant is placed at the higher position in the search listings, and with a current bid for the senior merchant preferably set at to the amount of the junior merchant's proxy bid. The process 800 then proceeds accordingly through steps 878, 880, 882, and 884.

As yet another alternative, if the senior merchant's proxy bid is not greater than or equal to the junior merchant's proxy bid, then in a next step 888, each merchant's tentative positions are preferably hardened. Further, the junior merchant's current bid (i.e., initially set to its initial bid) is raised to the amount of the senior merchant's proxy bid plus a minimum monetary increment (e.g., one-cent). This additional increment is preferably required based the junior merchant's junior status with respect to the senior merchant. In a next step 890, however, the senior merchant's current bid is increased to the senior merchant's proxy bid. This step 890 is preferably performed to avoid the unfairness of requiring the setting of the junior merchant's current bid to the level of its proxy bid to maintain its tentative position caused by the senior merchant's proxy bid, without requiring the senior merchant to increase it own bid. Upon completion of this step 890, in the next steps 870, 872, the database initiates a message via the mail server 212 to the senior merchant of the senior merchant's drop in position.

In the cases where the junior merchant is dropped a position, in preferred embodiments, the step of comparing bids is repeated between the junior merchant and the next lower senior merchant. In other embodiments, the evaluation of proxy bids only occurs for determination as to the merchant that receives the top (i.e., highest) position in the search results listing.

Because of the automated nature of the steps of the bidding process and the resulting updates to the search results listing, the Bid-for-Rank capability of the marketplace search engine may be performed in real-time. Thus, when a merchant chooses to modify a bid, the steps necessary to effect the change to the search results listing may be automatically performed. Thus, the merchant can view the change immediately, and potentially, observe the results of that change immediately. Furthermore, the proxy bidding capability, where merchants need not explicitly authorize bid increases is made viable by a real-time system.

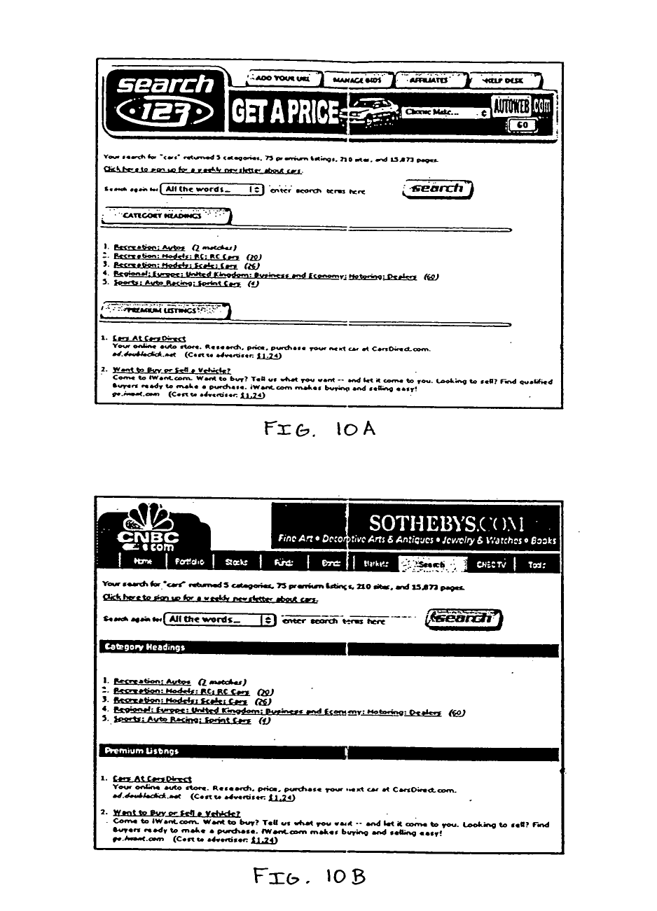

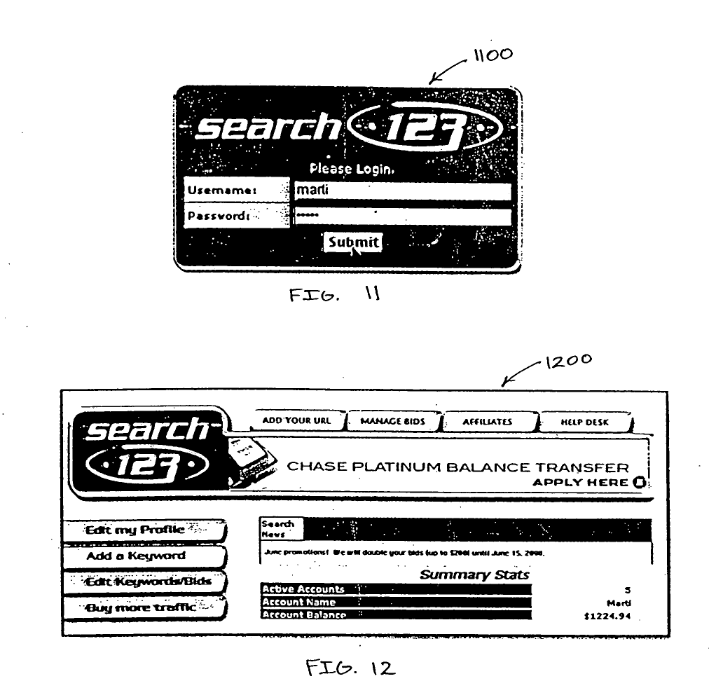

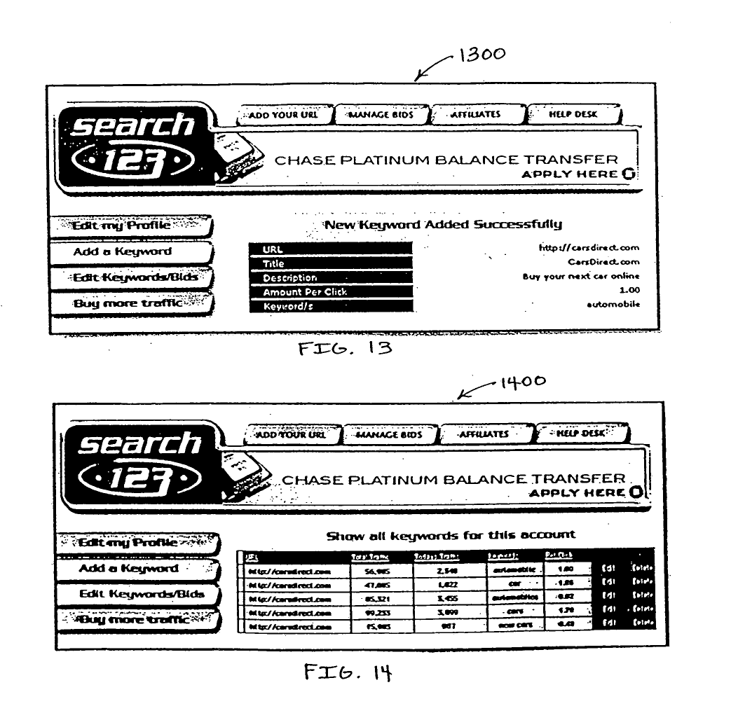

Preferably, merchants that have established accounts and keyword listings with the marketplace search engine 200 (or 104) can view different data regarding its accounts, the performance of its advertisements, and various statistical summaries. Preferably, the marketplace search engine 200 (or 104) preferably also provides interfaces for merchants to perform bidding and editing functions. FIG. 12, for example, depicts a screenshot 1200 of an HTML window providing a means for merchant profile entry, editing, and management and statistics display. Similarly, FIG. 13 depicts an example of a screenshot of an HTML window providing a profile summary screen for a specific keyword. As another example, FIG. 14 depicts an example of a screenshot 1400 of an HTML window providing a merchant account summary screen. FIG. 14 provides consumer traffic data for based on various keywords that are used to access a particular website. By enabling access to such summaries, the marketplace search engine 200 (or 104) provides merchants immediate feedback on the absolute and relative performance of their selected keywords, and provides merchants the ability to refine their advertisements to focus on specific keywords that are particularly effective at drawing consumer traffic.

Thus, in one preferred embodiment, a method of generating a target list of customers is comprised of the steps of:

(a) receiving a keyword from a customer for producing search results;

(b) obtaining and transmitting the search results to the customer;

(c) transmitting to the customer an invitation to be included in the target list related to the keyword;

(d) receiving from the customer an acceptance of the invitation to be included in the target list, the acceptance including contact information for the customer;

(e) transmitting a confirmation request using the contact information;

(f) receiving a confirmation of the acceptance from the customer; and

(g) adding the contact information to the target list related to the keyword.

In another preferred embodiment therefore, a system for generating a target list is comprised of:

(a) a processor for receiving a keyword, obtaining search results for the keyword, generating an invitation to be included in the target list, the target list being related to the keyword, generating a confirmation request in response to receiving an acceptance of the invitation, and submitting a target entry in response to receiving a confirmation of the acceptance;

(b) a memory connected to the processor for storing the search results, the target list; and the target entry in the target list; and

(c) a communication link to the processor, the communication link enabling the processor to receive the keyword, transmit the search results, transmit the invitation, receive the acceptance, transmit the confirmation request, and receive the confirmation of the acceptance.

In yet another preferred embodiment, a computer readable medium is provided having stored therein one or more sequences of instructions for generating a target list of customers, said one or more sequences of instructions causing one or more processors to perform a plurality of acts, said acts comprising:

(a) receiving a keyword from a customer for producing search results;

(b) obtaining and transmitting the search results to the customer;

(c) transmitting to the customer an invitation to be included in the target list related to the keyword;

(d) receiving from the customer an acceptance of the invitation to be included in the target list, the acceptance including contact information for the customer;

(e) transmitting a confirmation request using the contact information;

(f) receiving a confirmation of the acceptance from the customer; and

(g) adding the contact information to the target list related to the keyword.

In yet another preferred embodiment, a method of including a user on a target list comprises the steps of:

(a) specifying a keyword from which to generate search results;

(b) receiving the search results and an invitation to be included on the target list related to the keyword;

(c) transmitting an acceptance of the invitation to be included on the target list, the acceptance including contact information;

(d) receiving, based on the contact information, a confirmation request; and

(e) transmitting a confirmation of the acceptance.

In yet another preferred embodiment, a system for facilitating inclusion of a user on a target list is comprised of:

(a) a user input device for enabling a user to specify a keyword from which to generate search results, generating an acceptance of an invitation to the user to be included on the target list, the target list being related to the keyword and the acceptance including contact information, and generating a confirmation of the acceptance; and

(b) a user output device for presenting the invitation and a confirmation request to the user.

In yet another preferred embodiment, a method of purchasing advertising is comprised of the steps of:

(a) transmitting a keyword;

(b) receiving a list of advertisements related to the keyword, the advertisements being ordered in the list according to a pay price for each advertisement;

(c) entering and transmitting a bid price for a particular advertisement;

(d) receiving the list of advertisements, wherein the particular advertisement is inserted into the list in accordance with the ordering according to the pay price.

Alternatively, given the preferred embodiment above of the method of purchasing advertising, the method further comprises the steps of:

(c1) transmitting a location of a resource of information associated with the particular advertisement; and

(c2) transmitting the information upon a request of the resource.

Alternatively, given the preferred embodiments above of the method of purchasing advertising, step (d) is performed in response to transmitting the information from the resource.

Alternatively, given the preferred embodiments above of the method of purchasing advertising, the method further comprises the steps of:

(c3) electronically receiving a request for the information and transmitting the information; and

(c4) determining a relevance of the keyword to the resource; wherein step (d) is performed in response to a determination that the relevance meets predetermined criteria.

In yet another preferred embodiment, a system for purchasing advertising is comprised of:

(a) a user input device for specifying a keyword, the keyword identifying a target audience for the advertising, and for entering a bid price for a particular advertisement;

(b) a user output device connected to the user input device, the user output device for presenting a list of advertisements related to the keyword, the advertisements being ordered in the list according to a pay price for each advertisement, and for presenting the list of advertisements, wherein the particular advertisement is inserted into the list in accordance with the ordering according to the pay price; and

(c) a communication link with an advertiser for transmitting the keyword and the bid price, and for receiving the list of advertisements.

In yet another preferred embodiment, a method of buying advertising comprises the steps of:

(a) transmitting registration data to an advertiser;

(b) receiving a list of keywords;

(c) selecting and transmitting a keyword from the list of keywords;

(d) receiving a list of advertisements ordered according to a price for each advertisement;

(e) entering and transmitting a bid price for a new advertisement; and

(f) receiving the list of advertisements, wherein the new advertisement is inserted into the list in accordance with the ordering according to price.

In yet another preferred embodiment, a method of selling advertising comprises the steps of:

(a) receiving a keyword from a buyer;

(b) transmitting to the buyer a list of advertisements ordered according to a pay price for each advertisement in the list;

(c) receiving from the buyer a bid price for an advertisement related to the buyer; and

(d) transmitting to the buyer the list of advertisements, wherein the advertisement related to the buyer is inserted into the list in accordance with the ordering according to the listed price.

Alternatively, given the preferred embodiment above of selling advertising, the method further comprises the steps of:

(c1) receiving data on a location of a resource of information associated with the advertisement related to the buyer; and

(c2) electronically requesting the information from the resource.

Alternatively, given the preferred embodiments above of selling advertising, step (d) is performed in response to receiving the information from the resource.

Alternatively, given the preferred embodiments above of selling advertising, the method further comprises the steps of:

(c3) electronically receiving the information; and

(c4) determining from the information a relevance of the keyword to the resource;

wherein step (d) is performed in response to determining that the relevance meets predetermined criteria.

Alternatively, given the preferred embodiments above of selling advertising, the method further comprises the steps of:

(c1) receiving a location of an information resource associated with the advertisement related to the buyer;

(c2) electronically requesting and receiving the resource; and

(c3) determining a relevance of the keyword to the resource;

wherein step (d) is performed in response to determining that the relevance meets predetermined criteria.

Alternatively, given the preferred embodiments above of selling advertising, the method further comprises the steps of:

(c1) determining whether a proxy bid is associated with one of the advertisements in the list having a list price that is lower that the bid price from the buyer;

(c2) notifying a buyer of the one of the advertisements of a change in position in the list if the bid price exceeds the list price.

Alternatively, given the preferred embodiments above of selling advertising, the method further comprises the steps of:

(c1) identifying a proxy bid for one of the advertisements in the list;

(c2) comparing the proxy bid to the bid price from the buyer;

(c3) notifying a buyer of the one of the advertisements of a change in position in the list if the bid price exceeds the proxy bid.

In yet another preferred embodiment, a system for selling advertising is comprised of:

(a) a memory for storing a list of advertisements ordered according to a pay price for each advertisement in the list;

(b) a processor connected to the memory for receiving a keyword from a buyer, obtaining the list of advertisements from the memory, and reordering the list according to a pay price to produce a revised list in response to receiving a bid price; and

(c) a communication link for receiving from the buyer a bid price for an advertisement related to the buyer and for transmitting to the buyer the list of advertisements and the revised list.

In yet another preferred embodiment, a computer readable medium is provided having stored therein one or more sequences of instructions for selling advertising, said one or more sequences of instructions causing one or more processors to perform a plurality of acts, said acts comprising:

(a) receiving a keyword from a buyer;

(b) transmitting to the buyer a list of advertisements ordered according to a pay price for each advertisement in the list;

(c) receiving from the buyer a bid price for an advertisement related to the buyer; and

(d) transmitting to the buyer the list of advertisements, wherein the advertisement related to the buyer is inserted into the list in accordance with the ordering according to the listed price.

It will be apparent to those skilled in the art that various modifications, variations and additions can be made without departing from the scope or spirit of the invention. Thus, it is intended that the present invention cover the modifications, variations and additions provided that they come within the scope of the appended claims and their equivalents.

1. A method for providing auction-based advertising for merchants:
receiving from a merchant at least one keyword for bidding and at least one proposed internet address related to said keyword;
verifying that said keyword relates to said proposed internet address;
providing a list of current internet addresses returned by a search engine on said keyword, said list ordered by current bid prices for each such current internet address for said keyword;
receiving from said merchant a maximum bid on said keyword;
placing said proposed internet address into said list according to said maximum bid.

2. The method of claim 1 wherein said placing step comprises automatically determining the merchant bid at or below the maximum bid that orders the merchant internet address at an incrementally higher placement on the list than at least one of the current internet addresses and further comprises raising said merchant bid amount automatically if another merchant submits a higher bid on said keyword until said maximum bid amount is reached.

3. The method of claim 2 further comprising notifying a first merchant that the bid of a second merchant has exceeded the maximum bid amount of said first merchant.

4. The method of claim 3 wherein said first merchant is more highly placed on said list then said second merchant.

5. The method of claim 2 further comprising notifying said first merchant the amount said second merchant's bid has exceeded said first merchant's maximum bid amount.

6. The method of claim 1 wherein the verifying step comprises prohibiting bidding by said merchant if said keyword does not relate to said proposed internet address.

7. The method of claim 6 wherein said merchant is notified if said keyword does not relate to said proposed internet address.

8. The method of claim 1 wherein said maximum bid represents an amount said merchant is willing to pay per click when users access said internet address.

9. A method of providing auction-based advertising for a plurality of web sites in relation to a particular keyword comprising the steps of:
receiving a bid and a proxy amount from each of said web sites for said keyword;
ordering said websites on a list according to said bids;
adjusting said ordering by increasing said bids automatically until either a bid reaches its proxy amount or said bid is greater than the proxy amount of the next higher bidder.

10. The method of claim 9 wherein a first website is notified when the bid of a second web site exceeds the proxy amount of said first web site.

11. The method of claim 10 wherein said first website is senior in said ordering to said second web site.

12. The method of claim 10 further comprising notifying said first web site of the amount said second web site's bid exceeds the proxy amount of said first web site.

13. The method of claim 9 wherein each of said web sites is checked against said keyword, and said web site is not placed on said list unless said keyword relates to said web site.

14. The method of claim 13 wherein said web site is checked against said keyword by a web crawler.

15. The method of claim 13 wherein said web site is notified when said web site is not placed on said list.

16. The method of claim 9 wherein each of said web sites registers prior to bidding.

17. The method of claim 9 wherein said bid represents an amount a web site is willing to pay per click when users access said web site.

18. An auction-based advertising system for allowing merchants to bid on rank in having a search engine return a particular web site to a searcher comprising:
a computer network containing at least one computer;
a database accessible to said computer containing a list of web sites ordered in rank according to previous bids;
a bid receiving agent executing on said network receiving a bid for a new web site, wherein said agent inserts said new web site into said list in the database according to a rank computed from said bid;
a notification agent executing on said network notifying web sites in said database of insertions by said agent.

19. The auction-based advertising system of claim 18 wherein each bid also contains a proxy value higher than said bid, and wherein said bid receiving agent can increase bids prior to said insertion, no bid being increased higher than said proxy value.

20. The auction-based advertising system of claim 19 wherein said notification agent notifies web sites of the amount said bid exceeded the proxy value of that web site.
